(19) United States
(12) Patent Application Publication
(10) Pub. No.: US 2020/0175843 A1
(43) Pub. Date: Jun. 4, 2020

(54) METHODS AND SYSTEMS FOR FIRST RESPONDER ACCESS TO LOCALIZED PRESENCE AND IDENTIFICATION INFORMATION

(71) Applicant: AT& T Intellectual Property I, L.P., Atlanta, GA (US)

(72) Inventors: Atif Aslam, Mableton, GA (US); Jeffrey Mikan, Atlanta, GA (US); Joaquin Aguirre, Duluth, GA (US)

(21) Appl. No.: 16/207,694

(22) Filed: Dec. 3, 2018

(51) Int. Cl. G08B 27/00; H04L 29/08; H04W 4/33

(52) U.S. Cl. CPC G08B 27/001; H04W 4/33; H04L 67/12

(57) ABSTRACT

Concepts and technologies are disclosed herein for a system that allows first responders to access information relevant to the first responder, such as localized presence and identification information. According to one aspect, data is collected from a plurality of internet of things devices in a building. The data is converted into information relevant to a first responder. A trigger signal causes a processor to access a data store to retrieve a floorplan of the building and the information relevant to the first responder. The information relevant to the first responder is mapped to the floorplan and displayed in a display device.

### TECHNICAL FIELD

This disclosure relates to presence detection and more specifically to a method and system for determining the presence of persons in a building or campus during an emergency.

### BACKGROUND

There are many types of emergencies that require first responders to ascertain the presence and location of individuals in a defined space such as an office building. Examples of such emergencies may include structure fires, active shooter in a location such as a school, earthquakes, and the like. In such emergencies one of the first thing a first responder will do is to assess the scene, including determining how many individuals are inside the structure or location and where they are located. First responders may include firefighters, policemen, emergency medical services personnel, and the like. For example in the case of a fire, fire service response to a commercial or industrial building is typically initiated with a fire sensor signal relayed to an alarm company, followed by a 9-1-1 call. Presently, the information that reaches first responders about the fire incident is minimal. Consequently, standard operating procedure upon arrival at a building site is based on minimal situational awareness, requiring significant time after arrival to conduct an on-scene assessment.

There is a need to provide first responders to an emergency in a structure with reliable data about the presence and location of individuals in the structure.

### SUMMARY

One general aspect includes a method where a processor receives data from internet of things (IoT) devices in a building. The IoT data may be stored in a data store. The processor then receives a trigger signal. Upon receipt of the trigger signal the processor accesses a floorplan data store to retrieve a floorplan of the building. The processor converts the IoT data into information relevant to a first responder. The processor then maps the information relevant to a first responder to the floorplan to generate mapped information relevant to a first responder, and transmits the mapped information relevant to a first responder to a display device. Other embodiments of this aspect include corresponding computer systems, apparatus, and computer programs recorded on one or more computer storage devices, each configured to perform the actions of the methods.

Implementations may include one or more of the following features. The information relevant to a first responder such as presence information is developed from sensor data from a plurality of IoT devices in the building. The sensor data may be transmitted to the processor through a network. The mapped information relevant to a first responder may include data convertible into a display of the floorplan. Implementations of the described techniques may include hardware, or computer software on a computer-accessible medium.

One general aspect includes a system including a processor connected to a network capable of accessing IoT data from a plurality of IoT devices disposed in a building. An application programming interface capable of converting data from the IoT devices into information relevant to a first responder is provided. The system includes a floorplan data store containing a floorplan of the building. The system further includes a memory coupled to the processor and configured to store program instructions executable by the processor to: receive information relevant to a first responder; store the information relevant to a first responder in a first data store; receive a trigger signal; and access the floorplan data store to retrieve the floorplan of the building. The program instruction further include instructions to map the information relevant to a first responder to the floorplan to generate mapped information relevant to a first responder that is then transmitted to a display device. Other embodiments of this aspect include corresponding methods and computer programs recorded on one or more computer storage devices, each configured to perform the actions of the methods.

One general aspect includes a non-transitory computer-readable storage medium, including program instructions executable by a processor. The instructions include instructions to receive IoT data from a plurality of IoT devices. The instructions also include instructions to store the IoT data in a data store. The instructions include instructions to receive a trigger signal, and instructions to access a floorplan data store to retrieve a floorplan of the building. The instructions also include instructions to convert the IoT data into information relevant to a first responder, and instructions to map the presence information to the floorplan to generate mapped information relevant to a first responder The instructions further include instructions to transmit the mapped presence information to a display device. Other embodiments of this aspect include corresponding computer systems, and methods.

### BRIEF DESCRIPTION OF THE DRAWINGS

FIG. 1 is a block diagram illustrating a localized first responder information system.

FIG. 2 is a diagrammatic representation of a localized first responder information system as may be implemented in a multistory building.

FIG. 3 is a block diagram illustrating the interaction of localized first responder information system in a plurality of buildings.

FIG. 4 is a flowchart of a method to detect and display the presence and location of an individual in a building during an emergency.

FIG. 5 is a block diagram illustrating the data flow of an embodiment of a method to detect and display the presence and location of an individual in a building during an emergency.

FIG. 6 is a block diagram illustrating the data flow of an embodiment of a method to detect and display the presence and location of an individual in a building during an emergency.

FIG. 7 is a flowchart of a method to provide relevant information to a first responder in case of an emergency.

### DETAILED DESCRIPTION OF ILLUSTRATIVE EMBODIMENTS

Modern building automation systems have a wealth of sensor data which, when properly collected, analyzed, and communicated, can be made available remotely to responders and public safety networks in secure, interoperable formats. These include environmental systems, security systems, fire protection systems, energy management systems, lighting systems elevator systems, heating ventilation and air conditioning (HVAC) systems, etc. Each individual system processes and stores a large amount of data that is potentially useful to emergency responders. Such data would include floor plans of the building, sensor data from smoke and heat detectors, gas detectors, motion detectors, etc. Other information may include data from HVAC systems, door and elevator access, room occupancy, lights, and cameras. Sensors that provide the sensor data may be augmented with additional sensors to provide more granular data.

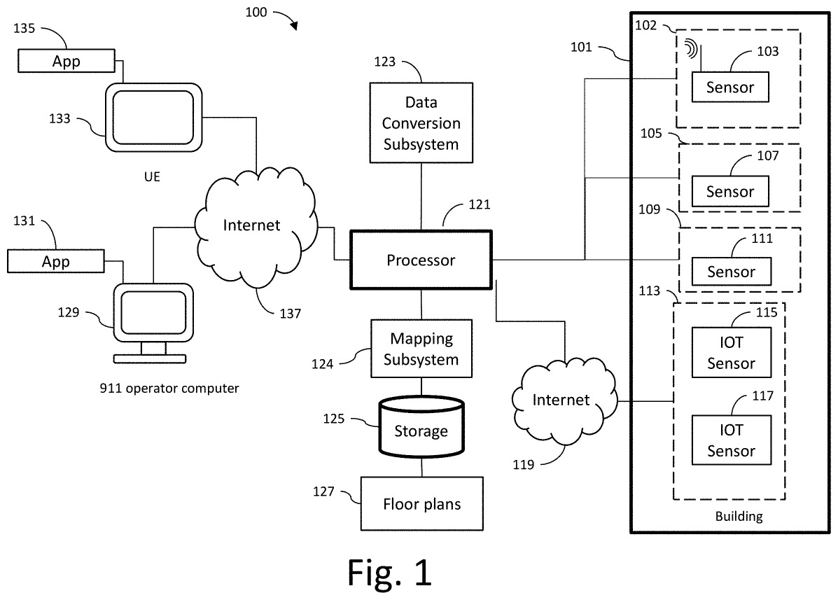

Illustrated in FIG. 1 is a first responder information system 100. First responder information system 100 includes a plurality of building systems disposed in a building 101. For example, building 101 may have a building system 102 that may include a wireless sensor 103, a building system 105 that may include a sensor 107, a building system 109 that may include a sensor 111, and an IoT system 113 that may include a pair of IOT sensors 115 and 117. IoT system 113 may be a system embedded with electronics, software, sensors, actuators and connectivity which enables these things to connect, collect and exchange data and which are typically connected to the Internet. As stated above, building system 102, building system 105, building system 109, and building system 113 may be environmental systems, security systems, fire protection systems, energy management systems, lighting systems elevator systems, HVAC Systems, smart meters, etc. IoT system 113 may include consumer connected devices such as smart TVs, smart speakers, toys, wearables and smart appliances. The present disclosure contemplates a variety of types of sensors which may be disposed in the building 101. Among the sensors that may be used are temperature sensors, proximity (motion detection) sensors, pressure sensors, optical sensors (e.g. passive infrared sensors), etc. The sensors may be hard wired or wireless. The sensors may be used with a variety of building systems, for example a motion detection sensor may be used in a lighting system to determine when the light should be turned off, or in a security system to determine when there has been an unauthorized entry into a secure area. Sensors may be used for occupancy sensing for energy management control systems such as lighting control systems, HVAC control systems, Demand Side Management (DSM) electrical load management control systems, presence monitoring systems, and for security sensing in security systems. Passive Infrared (PIR) sensors, typically 8 to 14 micron wavelength are frequently used as occupancy sensors in security systems, and in energy management control systems such as lighting control systems or HVAC systems or DSM systems. Passive infrared sensors frequently comprise a segmented lens, such as a Fresnel lens, wherein the segments of the lens establish different optical lobes in the field of view, and an IR pyroelectric detector, and detect movement of IR sources within the field of view of the detector. Accordingly, such Passive Infrared (PIR) sensors can be used as occupancy sensors in security systems and also in energy management control systems such as in lighting control systems or HVAC systems or DSM systems and also in presence monitoring systems. PIR sensors work on heat difference detection, measuring infrared radiation. Inside the device is a pyroelectric sensor which can detect the sudden presence of objects (such as humans) who radiate a temperature different from the temperature of the background, such as the room temperature of a wall. Occupancy sensors may be motion detecting devices used to detect the presence of a person to automatically control lights or temperature or ventilation systems. The sensors use infrared, ultrasonic, microwave, or other technology. The term encompasses devices as different as PIR sensors, hotel room keycard locks and smart meters. Occupancy sensors are typically used to save energy, provide automatic control, and comply with building codes. Environmental sensors, such as temperature, humidity and CO2 sensors, may detect the change in the environment due to the presence of a person. Ultrasonic sensors send high frequency sound waves in area and will check for their reflected patterns. If the reflected pattern is changing continuously then it assumes that there is occupancy and the lighting load connected is turned on. If the reflected pattern is the same for a preset time then the sensor assumes there is no occupancy and the load is switched off. A microwave sensor sends high frequency microwaves in an area and will check for their reflected patterns. If the reflected pattern is changing continuously then it assumes that there is occupancy and the lighting load connected is turned on. If the reflected pattern is the same for a preset time then the sensor assumes there is no occupancy and the load is switched off. A microwave sensor has high sensitivity as well as detection range compared to other types of sensors. Keycard light slots, used in a hotel energy management system to detect when a hotel room is occupied, by requiring the guest to place their keycard in a slot to activate lights and thermostats. Smart meters, which work by detecting the change in power consumption patterns that exhibit distinct characteristics for occupied and vacant states. Indoor occupancy measurement plays an indispensable role in occupant-based intelligent control of building systems for energy conservation. Office surveillance videos may also provide data from which occupancy may be determined.

The first responder information system 100 includes a processor 121 which may be connected to the IoT systems (e.g. IoT System 102, IoT system 105, IoT system 109 and IoT system 113) through a network, a wireless device or directly hardwired. The processor 121 may include a central processing unit (CPU) and a graphics processing unit (GPU). The processor 121 may access a data store 125 that may be used to store data generated by the IoT systems and data associated with the floor plans of building 101. In one embodiment the data associated with the floor plans of building 101 may be stored separately in a data store operated by the building management, alternately in a data store operated by a local government permitting authority. The data store 125 may include any type of a variety of storage types such as magnetic storage, optical storage, flash storage and cloud storage.

Associated with the processor 121 may be a data conversion subsystem 123 that converts data from the sensors into information relevant to first responders (e.g. presence information). For example, if the IoT system is a thermostat coupled to a motion detector the data conversion subsystem 123 may convert data relating to motion that has been detected by the motion detector into data indicating the presence of an individual at that location in the building.

Associated with the processor 121 may be a mapping subsystem 124 that accesses a data store 125 where floorplans of buildings are stored. The mapping subsystem 124 may be an application that integrates the information relevant to the first responder with the floor plan of a building to generate information relevant to the first responder mapped to the relevant floorplan (mapped first responder information). For example, if the information relevant to the first responder is information about the presence of an individual in a room the mapping subsystem 124 integrates presence information from the data conversion subsystem 123 with a floorplan of the building to generate mapped presence information. Data store 125 may also be used to store the information relevant to the first responder generated by the data conversion subsystem 123.

Access to the first responder information may be controlled by authentication policies to ensure that only first responders in an emergency have access to the data. For example the data may be made unavailable unless there has been an emergency trigger such as a fire alarm, a security alarm, a 911 call was a detection of some other emergency.

The first responder information system 100 may also include a 911 operator computer 129 having an application 131 capable of converting the mapped first responder information (e.g. presence information) into a visual display of the floor plan and the information relevant to the first responder (e.g. the location of the individual in the floorplan). In another embodiment the first responder information system 100 may include a user equipment 133 with an application 135 capable of converting the mapped first responder information (e.g. presence information) into a visual display of the floor plan and the information relevant to the first responder (e.g. the location of the individual in the floorplan). User equipment 133 may be a smart phone, lap top, notebook, web book, smart watch, personal digital assistant, data messaging device, a two-way pager, a wireless e-mail device, a cellular telephone with data messaging capabilities, a wireless Internet appliance, a wireless communications device, or a data communication device, as examples. User equipment 133 and 911 operator computer 129 may access the processor 121 through a network, for example the Internet 137.

In operation the first responder information system 100 allows a first responder operating a user equipment 133, or a 911 operator operating a 911 operator computer 129 to access the processor 121 that provides the user equipment 133 or the 911 operator computer 129 with information relevant to the first responder (e.g. presence data) in case of an emergency. For example, in case of a fire the first responder or 911 operator may access presence data in data store 125 to determine the location of individuals in a burning building. As further described below, the presence data may be continuously stored in the data store 125, or stored for a predetermined interval of data (e.g. 15 minutes) in a buffer. In an embodiment, the storage may be initiated by an emergency trigger such as a fire alarm. In another embodiment the trigger may be the sound of a gunshot, a 911 call, a security alarm, or other action signaling in emergency.

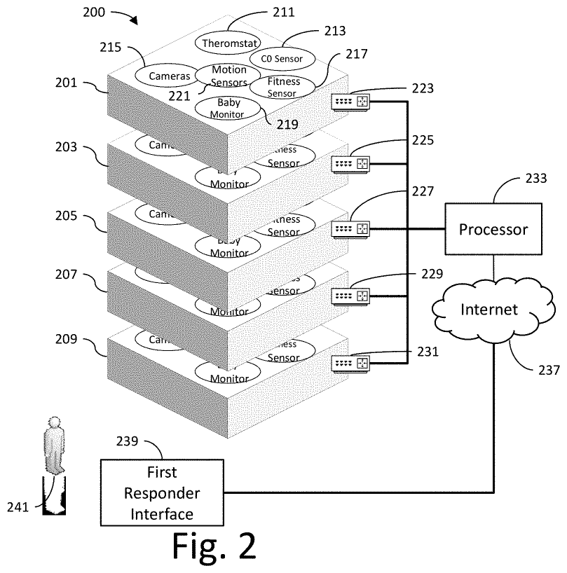

Illustrated in FIG. 2 is a first responder information system 200 disposed in a building having a plurality of floors (floors 201-209). The system may include in each floor one or more IoT devices such as thermostats 211, carbon monoxide sensors 213, cameras 215, fitness sensors 217, baby monitors 219 and motion sensors 221, among others. Associated with each floor may be a gateway for example, gateway 223 may be associated with floor 201, gateway 225 may be associated with floor 203, gateway 227 may be associated with floor 205 gateway 229 may be associated with floor 207 and gateway 231 may be associated with floor 209. The gateways may be connected to a processor 233 which in turn is connected through a network 237 to a first responder interface 239 can be accessed by a first responder 241.

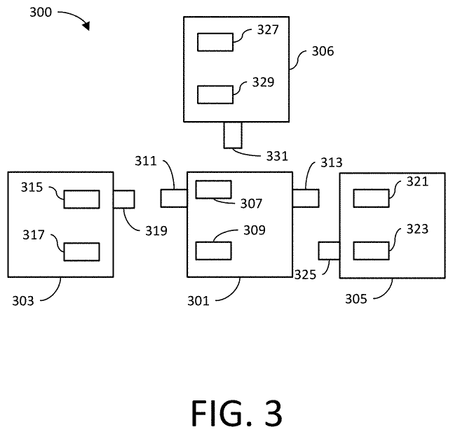

Illustrated in FIG. 3 is a use case 300 related to the use of the first responder information system 100 in connection with building adjacencies. In this embodiment a plurality of buildings (building 301, building 303, building 305 and building 306) are disposed in close proximity to each other. Building 301 may have internal IoT systems 307 and 309. IOT systems 307 309 may include thermostats, fire detection systems, security systems, or other systems with sensors that can detect the presence of individuals in the building. Building 301 may have external IoT systems 311 and 313 such as for example security television cameras. Building 303 may have internal IoT systems 317 and 315 and an external IoT system 319. Building 305 may have internal IoT systems 321 and 323 and an external IoT system 325. Building 306 may have internal IoT systems 327 and 329 and external IoT system 331. Associated with each building is a trigger detection subsystem (not shown) and a presence detection system (not shown). An emergency trigger associated with building 305 will cause the presence system in building 305 to initiate the detection of individuals in building 305 through the detection of data from IoT device 321 and IoT device 323. The trigger may also cause the external IoT device 325 to begin recording data that may be of interest to the first responder. In this use case the triggering of external IOT device 325 may also trigger IOT device 313 in building 301 to begin collecting external data relevant to the emergency in building 305.

In an embodiment the presence detection system and building 301 may interact with the presence detection system in buildings 303, 305 and 306 to provide a cascading alert of an emergency. For example, building 305 may be an apartment building with an active shooter. The sound of a gunshot triggers the operation of the presence detection system in building 305. The presence detection system in building 305 may access external IoT system 313, for example a television camera facing the apartment building. If building 301 is a school building the presence system in building 301 may be programmed to initiate a lockdown if the presence system in buildings 305 or building 303 detect a gunshot. If building 306 is a house the presence system and building 306 may be programmed to lock all doors and closed garage doors if a gunshot has been detected by presence system in building 305.

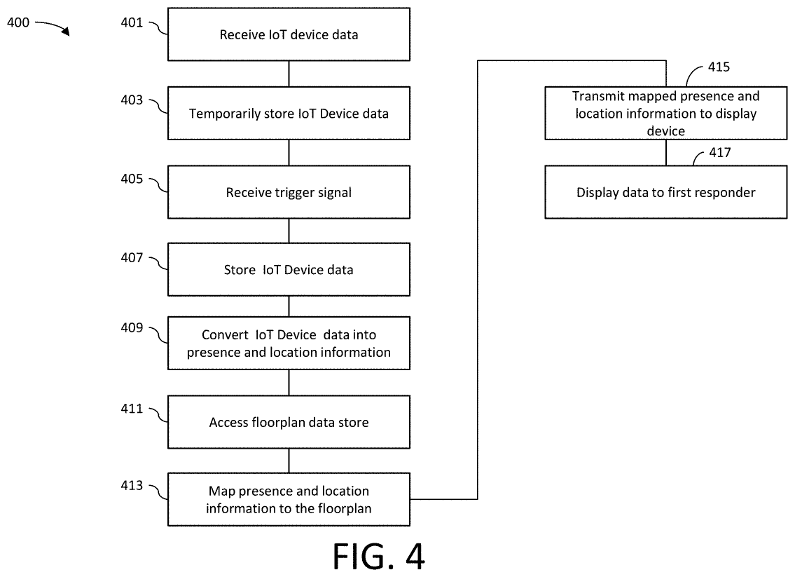

Illustrated in FIG. 4 is a flowchart of a method 400 to detect and display the information relevant to a first responder (e.g. presence and location of an individual in a building) during an emergency.

In step 401 the method 400 receives IoT device data into a processor. The IoT device data may include data from smart thermostats, carbon monoxide detectors, cameras, fitness sensors, baby monitors, and motion detectors, and security systems among others. For example, a smart thermostat may be coupled with a motion detector to regulate temperature when no one is present in a room. The motion detector may provide data related to the detection of motion in the room.

In step 403 the IoT device data is stored into a data store. The data may be stored for a period of time (rolling window). In one embodiment the IOT device data is not stored into the data store until a trigger has been activated.

In step 405 the first responder information system may receive a trigger signal indicating an emergency requiring first responders. For example trigger may be a fire alarm, the sound of a gunshot, a security alarm, a 911 call or similar signal indicating an emergency.

In step 407 the first responder information system stores the IoT device data into a data store.

In step 409 the first responder information system converts the IoT device data into information relevant to a first responder (e.g. presence and location information). For example, in the case of a smart thermostat coupled with a motion detector, the motion detector data would be converted into data indicating the presence of an individual at the location of the motion detector. In another example, a smart television that has been turned on to provide the data that the television is on to the first responder information system which then converts the data into information relevant to a first responder (e.g. data indicating the presence of an individual at the location of the smart television).

In step 411 first responder information system may access a floorplan from a floorplan data store. The floorplan data store may be a storage device associated with the presence system, a storage device associated with the building management system, or a storage device associated with a local government permitting authority.

In step 413 the first responder information system will map the information relevant to the first responder (e.g. presence and location information) to the floorplan.

In step 415 the first responder information system will transmit the mapped information relevant to the first responder to a display device such as a first responder user equipment or a 911 operator computer.

In step 417 the first responder user equipment or 911 operator computer will convert the mapped information into a display showing the floorplan, the information relevant to the first responder and/or a link to the information relevant to the first responder displayed on the appropriate location in the floor plan (e.g. the location of individuals on the floorplan). The location of individuals on the floorplan may be indicated by a dot on the floorplan or by providing a color pattern for the room illustrated in the floorplan. In another embodiment, the information relevant to the first responder may be video from a camera in a specific room. In that embodiment the information displayed on the floorplan may be a link to the video displayed on the specific room on the floorplan.

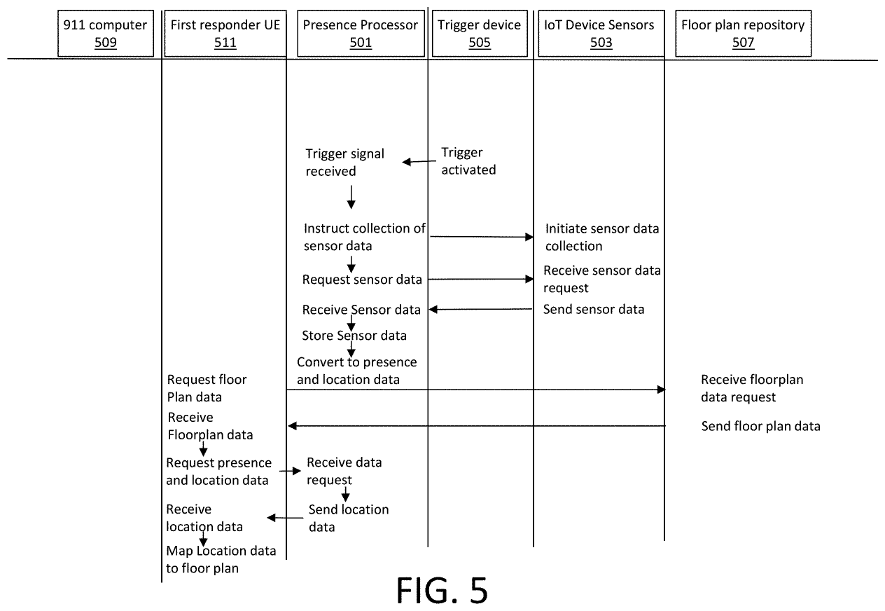

FIG. 5 is a block diagram illustrating the data flow of an embodiment of a method to detect and display the presence and location of an individual in a building during an emergency implemented by a system comprising a presence processor 501, a plurality of IoT device sensors 503, a trigger device 505, a floorplan repository 507, a 911 computer 509, and a first responder user equipment 511. FIG. 5 is a sequence diagram that illustrates the following processes. Initially a trigger is activated by trigger device 505. Trigger device 505 may be a fire alarm from the fire alarm system, a security alarm from a security alarm system, a 911 call, a gunshot detection system, or any detectable signal associated with the occurrence of an emergency. When the trigger is activated, presence processor 501 receives a trigger signal and instructs the collection of sensor data from the IoT device sensors 503. IoT device sensor 503 then begins to record data relevant to indicate the presence and location IoT device sensors 503 which provides sensor data to the presence processor 501. The sensor data may be stored in the data store associated with presence processor 501, and then converted to presence and location data by presence processor 501. Upon arrival at the building site a first responder may use it the first responder UE 511 to request floorplan data from floorplan repository 507. Floorplan repository 507 may be a data store of building floor plans maintained by building management, or a local government permitting authority. The floorplan repository 507 receives a floorplan data request and then sends the floorplan data to the first responder UE 511. The first responder UE 511 may then request presence and location data from the presence processor 501. Presence processor 501 receives the data requests and sends location and presence data to the first responder UE 511. The first responder UE 511 receives the presence and location data and then maps the presence and location data to the floorplan. In an alternate embodiment the request for the floorplan data and presence and location data may be made by 911 computer 509, which would then maps the presence and location data to the floorplan.

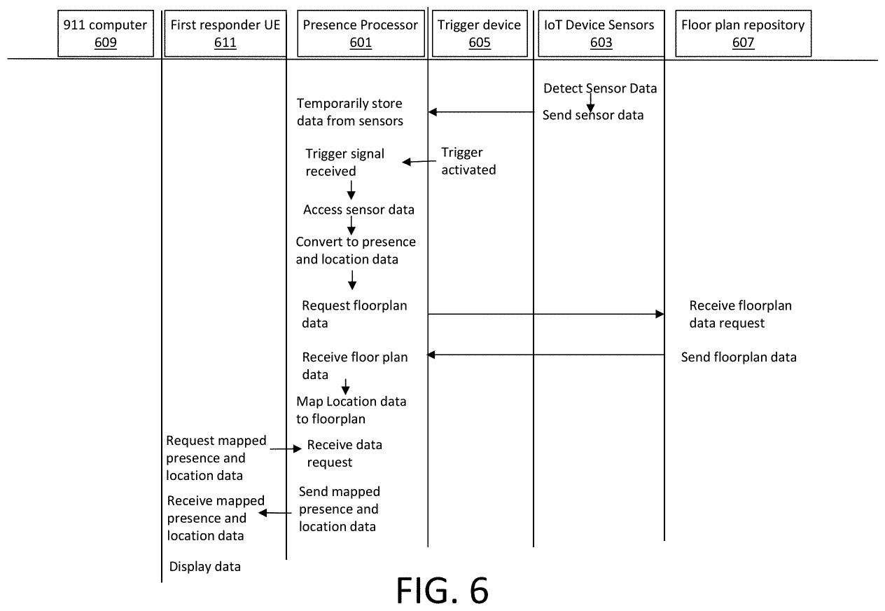

FIG. 6 is a block diagram illustrating the data flow of an embodiment of a method to detect and display the presence and location of an individual in a building during an emergency implemented by system comprising a presence processor 601. In this embodiment, sensor data is continuously sent to the presence processor 601 where it is temporarily stored. In an embodiment the data may be stored on a rolling window basis, meaning that after a defined period is achieved, for example 15 minutes of data storage, the first minute of data storage is recorded over by the 16^{th} minute of data storage so that only 15 minutes of sensor data is available at any one time. In an embodiment, when the trigger is activated, storage on a rolling window basis may be changed to continuous storage until the emergency is resolved. When the trigger signal is received the presence processor 601 converts the sensor data to presence and location data. The presence processor 601 then requests the floorplan data from the floorplan repository 607. After receiving the floorplan data the presence processor 601 maps the presence and location data to develop mapped presence and location data. The mapped presence and location data may be sent to the first responder UE 611 or to the 911 computer 609 where it is displayed.

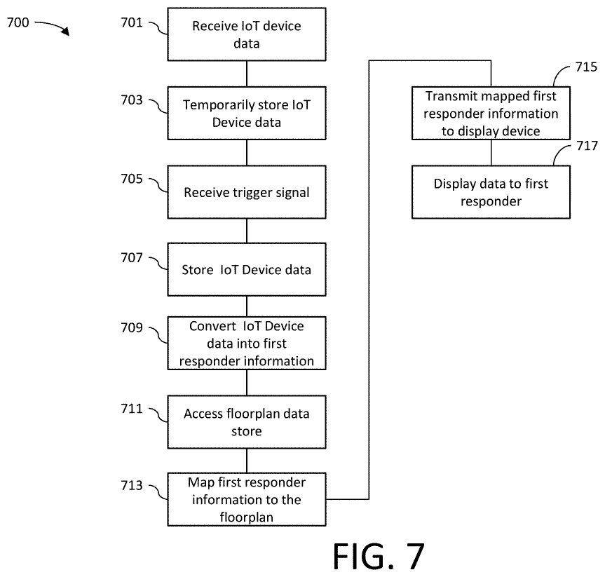

FIG. 7 illustrates another use case in the form of a method 700 to provide pertinent information to a first responder.

In step 701, the method 700 receives IoT device data into a first responder information system including a processor. The IoT device data may include data from smart thermostats, carbon monoxide detectors, cameras, fitness sensors, baby monitors, and motion detectors, and security systems among others. For example, a smart thermostat may provide room temperature data which may be used to determine if there is a fire in a room. In another example the security system may detect the sound of a firearm and provide that information which may be used to determine that there is an active shooter in a room. In yet another example, a video camera may record a camera view of a room that may be used by a first responder to determine if it is safe to enter the room.

In step 703, the IoT device data is stored into a data store. The data may be stored for a period of time (rolling window). In one embodiment the IOT device data is not stored into the data store until a trigger has been activated.

In step 705, the first responder information system may receive a trigger signal indicating an emergency requiring first responders. For example trigger may be a fire alarm, the sound of a gunshot, a security alarm, a 911 call or similar signal indicating an emergency.

In step 709, the first responder information system converts the IoT device data into relevant first responder information. For example, if the IoT device is a thermostat and the temperature is above a specified threshold in a room, the first responder relevant information may be that there is a fire in that room. Alternately, if the IoT device may be a camera (e.g. a nanny cam), the relevant first responder information may be the recorded image of the room, indicating that there is a fire, a person, a possible crime perpetrator such as a gun man or a potential booby trap or other dangerous devices.

In step 711, the first responder information system may access a floorplan from a floorplan data store. The floorplan data store may be a storage device associated with the first responder information system, a storage device associated with the building management system, or a storage device associated with a local government permitting authority.

In step 713, the first responder information system may map the information relevant to the first responder to the floorplan. For example, in the case of a fire alarm the first responder information system may map the room temperature information in a plurality of rooms onto a floor plan of the building. In the case of a police call the image of the room taken by a camera may be inserted as an icon on the room depicted in the floorplan.

In step 715, the first responder information system may transmit the mapped information relevant to the first responder to a display device such as a first responder user equipment or a 911 operator computer.

In step 417, the first responder user equipment or 911 operator computer will convert the mapped information relevant to the first responder into a display showing the floorplan and the relevant first responder information on the relevant location on floorplan.

The present disclosure contemplates a variety of IoT device data and information relevant to the first responder. For example the following table list some examples of IoT data and information relevant to the first responder.

| IoT Device Data | Information relevant to first responder |
|---|---|
| Data from temperature sensor in a smart | Location and presence of an individual in a |
| thermostat | room |
| Data from temperature sensor in a smart | Fire in the room |
| thermostat | |
| Data from motion detector in a smart | Location and presence of an individual in a |
| thermostat in a room | room |
| Data from a security system motion detector | Location and presence of an individual in a |
| in a room | room |
| Absence of data from a smart thermostat | Possible fire in a room that has disabled |
| connected to the first responder information | thermostat |
| system | |
| Video from camera in a room | Presence of an individual in the room in case |
| | of a fire; |
| | Presence of gunman in the room in case of an |
| | active shooter emergency call; |
| | Presence of booby trap in the room |
| Video from a smart doorbell device on an | Determine what is outside the elevator before |
| elevator | doors open |
| Data from a sound detection device | Information that a gun has been fired |
| Data from an electronic lock to a room | Presence of an individual in the room |
| Data from a smoke alarm in a room | Existence of a fire in the room |
| Data from a motion detector in a room | Presence of individual in the room |
| Data from smart television in a room | Presence of individual in the room |
| Data from elevator system | Indication that elevators are functional |
| Data from a biosensor array in a room | Presence of individual in the room |
| Data from an RFID security system with GPS | Presence of individual at a location |
| tags | |
| Data from a baby monitor in a room | Presence of individual in the room |
| Data from a fitness device | Presence of individual at a location |
| Data from energy management system | Availability of electrical power in a room in |
| | building |

The processor discussed above may comprise one or more processors, together with input/output capability and computer readable storage devices having computer readable instructions stored thereon that, when executed by the processors, cause the processors to perform various operations. The processors may be dedicated processors, or may be mainframe computers, desktop or laptop computers or any other device or group of devices capable of processing data. The processors are configured using software according to the present disclosure.

Each of the hardware elements may also include memory that functions as a data memory that stores data used during execution of programs in the processors, and is also used as a program work area. The memory may also function as a program memory for storing a program executed in the processors. The program may reside on any tangible, non-volatile computer-readable storage device as computer readable instructions stored thereon for execution by the processor to perform the operations.

Generally, the processors are configured with program modules that include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers and the like, and may employ a distributed computing environment, where tasks are performed by remote processing devices that are linked through a communications network. In a distributed computing environment, modules may be located in both local and remote memory storage devices.

An exemplary processing module for implementing the methodology above may be stored in a separate memory that is read into a main memory of a processor or a plurality of processors from a computer readable storage device such as a ROM or other type of hard magnetic drive, optical storage, tape or flash memory. In the case of a program stored in a memory media, execution of sequences of instructions in the module causes the processor to perform the process operations described herein. The embodiments of the present disclosure are not limited to any specific combination of hardware and software.

The term “computer-readable medium” as employed herein refers to a tangible, non-transitory machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. The terms “tangible media” and “non-transitory media” each exclude transitory signals such as propagated signals, which are not tangible and are not non-transitory. Cached information is considered to be stored on a computer-readable medium. Common expedients of computer-readable media are well-known in the art and need not be described in detail here.

The forgoing detailed description is to be understood as being in every respect illustrative and exemplary, but not restrictive, and the scope of the disclosure herein is not to be determined from the description, but rather from the claims as interpreted according to the full breadth permitted by the patent laws. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. It is to be understood that various modifications will be implemented by those skilled in the art, without departing from the scope and spirit of the disclosure.

1. A method comprising:
receiving, in a processor, data from internet of things devices in a building;
storing the data from the internet of things devices in a data store coupled to the processor;
receiving a trigger signal at the processor;
responsive to the trigger signal, accessing though the processor a floorplan data store to retrieve a floorplan of the building;
responsive to the trigger signal, initiating by the processor mitigating actions based on a type of trigger;
converting the data from the internet of things devices into information relevant to a first responder;
mapping the information relevant to the first responder to the floorplan to generate mapped information relevant to the first responder; and
transmitting the mapped information relevant to the first responder onto a display device.

2. The method of claim 1 wherein receiving the internet of things device data comprises receiving sensor data from a plurality of internet of things devices in the building.

3. The method of claim 2 wherein the sensor data is generated by sensors in the plurality of internet of things devices.

4. The method of claim 3 wherein the sensor data is transmitted to the processor through a network.

5. The method of claim 1 wherein the trigger signal is selected from a group comprising; a fire alarm; a smoke alarm; a 911 call; detection of a gunshot; and a security alarm.

6. The method of claim 1 wherein the information relevant to the first responder comprises location information.

7. The method of claim 1 wherein the mapped information relevant to the first responder comprises data convertible into a display of the floorplan with an indication of a location for each of a plurality of individuals.

8. A system comprising:
a processor connected to a network capable of accessing internet of things data from a plurality of internet of things devices disposed in a building;
an application programming interface capable of converting the internet of things data into information relevant to a first responder;
a floorplan data store containing a floorplan of the building;
a memory coupled to the processor and configured to store program instructions executable by the processor to:
receive the information relevant to the first responder;
store the information relevant to the first responder in a first data store;
receive a trigger signal;
initiate mitigation actions based on the trigger signal;
access the floorplan data store to retrieve the floorplan of the building;
map the information relevant to the first responder to the floorplan to generate mapped information relevant to the first responder; and
transmit the mapped information relevant to the first responder to a display device.

9. The system of claim 8 wherein the plurality of internet of things devices comprise a plurality of sensors embedded into the internet of things devices that detect data associated with an individual's presence.

10. The system of claim 8 wherein each of the plurality of internet of things devices is selected from among a group comprising: a smoke alarm, a motion detector; a camera; a smart television; a smart thermostat; an energy management system, an elevator system; a biosensor array; an RFID security system with GPS tags; an electronic lock system; a baby monitor; and a fitness device.

11. The system of claim 8 wherein the trigger signal is selected from a group comprising; a fire alarm; a smoke alarm; a 911 call; detection of a gunshot; and a security alarm.

12. The system of claim 8 wherein the information relevant to the first responder comprises location information.

13. The system of claim 8 wherein the mapped information relevant to the first responder comprises data convertible into a display of the floorplan with an indication of a location for each of a plurality of individuals.

14. The system of claim 8 wherein the memory coupled to the processor configured to store program instructions comprises memory coupled to the processor and configured to store program instructions executable by the processor to receive a request for the information relevant to the first responder.

15. The system of claim 8 wherein the display device is selected from a group comprising a 911 operator computer; and a first responder user equipment.

16. A non-transitory computer-readable storage medium, comprising program instructions, wherein the program instructions are executable by a processor to:
receive internet of things data from a plurality of internet of things devices;
convert the internet of things data into information relevant to a first responder;
store the information relevant to the first responder in a data store;
receive a trigger signal;
initiating mitigating actions based on the trigger signal;
access a floorplan data store to retrieve a floorplan of a building;
map the information relevant to the first responder to the floorplan to generate mapped information relevant to the first responder; and
transmit the mapped information relevant to the first responder to a display device.

17. The non-transitory computer-readable storage medium of claim 16 wherein the program instructions to receive internet of things data from a plurality of internet of things devices comprises program instructions executable by the processor to receive sensor data from a plurality of internet of things devices in the building.

18. The non-transitory computer-readable storage medium of claim 17 wherein the sensor data is generated by sensors in the plurality of internet of things devices.

19. The non-transitory computer-readable storage medium of claim 17 wherein the program instructions executable by the processor to receive sensor data from the plurality of internet of things devices in the building comprise program instructions executable by the processor to access the sensor data through a network.

20. The non-transitory computer-readable storage medium of claim 17 wherein the program instructions executable by the processor to map the information relevant to the first responder comprises program instructions executable by the processor to generate data convertible into a display of the floorplan with an indication of a location for each of a plurality of individuals.
